(19) United States
(12) Patent Application Publication
(10) Pub. No.: US 2025/0199260 A1
(43) Pub. Date: Jun. 19, 2025

(54) FIBER MANAGEMENT PORTION THAT IS STRUCTURALLY CONFIGURED TO PROVIDE A MODULAR FIBER CABLE PATCHING SYSTEM AND ENHANCE INSTALLATION

(71) Applicant: PPC BROADBAND, INC., East Syracuse, NY (US)

(72) Inventors: Jerin RAJ, Coimbatore (TN) (IN); Afzal V. ABDULSALAM, Edathala (KL) (IN)

(73) Assignee: PPC BROADBAND, INC., East Syracuse, NY (US)

(21) Appl. No.: 18/988,774

(22) Filed: Dec. 19, 2024

Related U.S. Application Data
(60) Provisional application No. 63/674,820, filed on Jul. 24, 2024.

(30) Foreign Application Priority Data
Dec. 19, 2023 (IN) 202311086803

(51) Int. Cl. G02B 6/44

(52) U.S. Cl. CPC G02B 6/44528; G02B 6/44526

(57) ABSTRACT

A modular fiber cable patching system may include a base portion and a fiber management portion structurally configured to be received in the base portion. The fiber management portion may include a holding portion structurally configured to removably receive a patching portion and a storage portion structurally configured to store a fiber optic cable. The storage portion may include a spool holder portion structurally configured to releasably mount a cable spool portion for rotation relative to the spool holder portion. The storage portion may be structurally configured to detach from the holding portion such that the holding portion and the storage portion are structurally configured to be used separately or together as a standalone arrangement. The fiber management portion may be structurally configured to slide into the base portion via an open front side of the base portion and an open rear side of the base portion.

### CROSS-REFERENCE TO RELATED APPLICATION

This application claims the benefit of Indian Provisional Patent Application No. 202311086803, filed Dec. 19, 2023, and U.S. Provisional Patent Application No. 63/674,820, filed Jul. 24, 2024, which are currently pending, the disclosures of which are hereby incorporated by reference herein in their entireties.

### TECHNICAL FIELD

The present disclosure relates generally to fiber optic cable patching systems, and more particularly to modular fiber optic cable patching arrangement.

### BACKGROUND

A patch panel in a fiber optic network is a mounted hardware assembly that contains ports that are used to connect and manage incoming and outgoing fiber optic cables. A patch panel provides a way to keep large numbers of cables organized and, enables flexible connectivity into network hardware. Patch panels come in fixed or modular form factors. A fixed patch panel has connectors that cannot be changed or altered. Modular patch panels can swap out the connector types, enabling increased flexibility when it comes to terminating different types of fiber optic cabling.

Some designs include modules that can be removed and interchanged with the patch panel. Each module can include a plurality of connectors and spools for holding excess cable. While modular design add flexibility relative to fixed panel design, there are still limitations to known modular designs, such as lack of scalability.

Therefore, it may be desirable to provide an improved modular design addressing some of the limitations of current modular design is desirable. For example, it may be desirable to provide a fiber management portion that is structurally configured to provide a modular fiber cable patching arrangement that is structurally configured to provide a modular fiber cable patching system and enhance installation. It may be desirable to provide a storage portion structurally configured to be releasably attached to a holding portion such that the holding portion and the storage portion are structurally configured to be used separately or together as a standalone arrangement so as to provide a modular fiber cable patching system. It may be desirable to provide the storage portion with a stop portion that is structurally configured to prevent rotation of a cable spool relative to a spool holder portion when the cover portion is in a closed position. It may be desirable to provide a storage portion that is structurally configured to removably receive a cable spool having an oval shape so as to enhance the storage capacity of slack cable and/or enhance installation of the fiber management arrangement.

### SUMMARY

According to various embodiments of the present disclosure, a module fiber cable patching system may include a base, or base portion, and a plurality of patching assemblies, or patching portions, structurally configured to be received in the base.

In some embodiments, a modular fiber cable patching arrangement may include a base portion and a fiber management portion structurally configured to be received in the base portion.

In some embodiments, the fiber management portion may include a holding portion structurally configured to removably receive a patching portion and a storage portion structurally configured to store a fiber optic cable.

In some embodiments, the holding portion and a storage portion may be structurally configured to be removably coupled with one another.

In some embodiments, the one or more patching portions may be structurally configured to patch one or more input fibers to one or more output fibers.

In some embodiments, the storage portion may include a spool holder portion structurally configured to releasably mount a cable spool portion within the spool holder portion for rotation relative to the spool holder portion.

In some embodiments, the storage portion may include a cover portion attached to the spool holder portion. The cover portion may be structurally configured to be move between an open position and closed position to cover the cable spool portion within the spool holder portion. In some embodiments, in the closed position, the cover portion may be structurally configured to prevent rotation of the cable spool portion relative to the spool holder portion.

In some embodiments, the storage portion may be structurally configured to detach from the holding portion such that the holding portion and the storage portion are structurally configured to be used separately or together as a standalone arrangement so as to provide a modular fiber cable patching system.

In some embodiments, the fiber management portion may be structurally configured to slide into the base portion via an open front side of the base portion and an open rear side of the base portion.

In some embodiments, the fiber cable patching system may include a first attachment portion structurally configured to attach a front portion of the storage portion to a back portion of the holding portion and allow the storage portion to be detached from the holding portion.

In some embodiments, the modular fiber cable patching system may include a second attachment portion structurally configured to releasably attach the one or more patching portions to a front portion of the holding portion.

In some embodiments, the spool holder portion may include a retaining portion structurally configured to move between a secure position in which the retaining portion secures the cable spool portion in the spool holder portion and a release position in which the cable spool portion may be removed from the spool holder portion. In some embodiments, the retaining portion may include a pair of flexible portions structurally configured to flex in order to move the retaining portion from the secure position to the release position.

In some embodiments, the cover portion may include a projecting portion extending from an inner face of the cover portion. In some embodiments, the projecting portion may be structurally configured to flex the pair of flexible portions into engagement with the cable spool portion to prevent rotation of the cable spool portion relative to the spool holder portion.

In some embodiments, the cable spool portion may have an oval shape and the storage portion may be structurally configured to store the cable spool portion so as to enhance a storage capacity of excess length of the fiber optic cable.

In some embodiments, the holding portion may be structurally configured to support a pair of patching portions structurally configured for 12F cable or a single patching portion structurally configured for 24F.

In some embodiments, the cable spool holder portion may be structurally configured to route the fiber optic cable out of a front portion and a back portion of the storage portion.

In some embodiments, a modular fiber cable patching system may include a base portion and a fiber management portion structurally configured to be received in the base portion. In some embodiments, the fiber management portion may include a holding portion structurally configured to support one or more patching portions, a storage portion, a storage portion structurally configured store a fiber optic cable, a first attachment portion structurally configured to attach the storage portion to the holding portion, and a second attachment portion structurally configured to attach the one or more patching portions to the holding portion.

In some embodiments, the holding portion may have a front portion and a back portion and the storage portion having a front portion and a back portion. In some embodiments, the first attachment portion may be structurally configured to attach the front portion of the storage portion to the back portion of the holding portion and allow the storage portion to be detached from the holding portion. In some embodiments, the second attachment portion may be structurally configured to attach the one or more patching portions to the front portion of the holding portion and allow the one or more patching portions to be detached from the holding portion.

In some embodiments, the one or more patching portions may be structurally configured to patch one or more input fibers to one or more output fibers.

In some embodiments, the storage portion may include a spool holder portion structurally configured to mount a cable spool portion within the storage portion.

In some embodiments, the spool holder portion may include a support portion structurally configured to support the cable spool portion within the spool holder portion for rotation relative to the spool holder portion.

In some embodiments, the spool holder portion may include a retaining portion structurally configured to move between a secure position in which the retaining portion secures the cable spool portion in the spool holder portion and a release position in which the cable spool portion may be removed from the spool holder portion.

In some embodiments, the storage portion may include a cover portion attached to the spool holder portion and structurally configured to be move between an open position and closed position to cover the cable spool portion within the spool holder portion.

In some embodiments, the cover portion may include a stop portion structurally configured to prevent rotation of the cable spool portion relative to the spool holder portion when the cover portion is in the closed position.

In some embodiments, the cable spool portion may have an oval shape and the storage portion may be structurally configured to store the cable spool portion so as to enhance a storage capacity of excess length of the fiber optic cable.

In some embodiments, the front portion of the storage portion may be structurally configured detach from the back portion of the holding portion such that the holding portion and the storage portion are structurally configured to be used separately or together as a standalone arrangement so as to provide a modular fiber cable patching system.

In some embodiments, the fiber management portion may be structurally configured to slide into the base portion via an open front side of the base portion and an open rear side of the base portion.

In some embodiments, the retaining portion may include a pair of flexible portions structurally configured to flex in order to move the retaining portion from the secure position to the release position.

In some embodiments, the stop portion may include a projecting portion extending from an inner face of the cover portion. In some embodiments, the projecting portion may be structurally configured to flex the pair of flexible portions into engagement with the cable spool portion to prevent rotation of the cable spool portion relative to the spool holder portion.

In some embodiments, the spool holder portion may be structurally configured to route the fiber optic cable out of the front portion and the back portion of the storage portion.

In some embodiments, the cable spool portion may include an engagement portion. In some embodiments, the retaining portion may be structurally configured to engage the engagement portion to prevent the cable spool portion from being removed from the spool holder portion. In some embodiments, the support portion may be structurally configured to engage the engagement portion to support the cable spool portion in the spool holder portion.

In some embodiments, a modular fiber cable patching system may include a base portion and a fiber management portion structurally configured to be received in the base portion.

In some embodiments, the fiber management portion may include a holding portion, a storage portion, a first attachment portion, and a second attachment portion. In some embodiments, the holding portion may include a front portion and a back portion and may be structurally configured to support one or more patching portions. In some embodiments, the storage portion may include a front portion and a back portion and be structurally configured to store a fiber optic cable.

In some embodiments, the first attachment portion may be structurally configured to attach the storage portion to the holding portion and allow the storage portion to be detached from the holding portion. In some embodiments, the second attachment portion may be structurally configured to attach the one or more patching portions to the holding portion and allow the one or more patching portions to be detached from the holding portion.

In some embodiments, the storage portion may include a spool holder portion structurally configured to mount a cable spool portion within the storage portion.

In some embodiments, the spool holder portion may be structurally configured to support the cable spool portion within the spool holder portion for rotation relative to the spool holder portion.

In some embodiments, the storage portion may include a retaining portion structurally configured to move between a secure position in which the retaining portion secures the cable spool portion in the spool holder portion and a release position in which the cable spool portion may be removed from the spool holder portion.

In some embodiments, the storage portion may include a stop portion structurally configured to prevent rotation of the cable spool portion relative to the spool holder portion.

In some embodiments, the storage portion may be structurally configured to detach from the holding portion such that the holding portion and the storage portion are structurally configured to be used separately or together as a standalone arrangement so as to provide a modular fiber cable patching system.

In some embodiments, the fiber management portion may be structurally configured to slide into the base portion via an open front side of the base portion and an open rear side of the base portion.

In some embodiments, the storage portion may include a cover portion attached to the spool holder portion. In some embodiments, the cover portion may be structurally configured to be move between an open position and closed position to cover the cable spool portion within the spool holder portion.

In some embodiments, the stop portion may be positioned on the cover portion and may be structurally configured to prevent rotation of the cable spool portion relative to the spool holder portion when the cover portion is in the closed position.

In some embodiments, the cable spool portion may have an oval shape and the storage portion may be structurally configured to store the cable spool portion so as to enhance a storage capacity of excess length of the fiber optic cable.

In some embodiments, the holding portion may be structurally configured to support a pair of patching portions structurally configured for 12F cable or a single patching portion structurally configured for 24F.

In some embodiments, the cable spool portion may include an engagement portion. In some embodiments, the retaining portion may be structurally configured to engage the engagement portion to prevent the cable spool portion from being removed from the spool holder portion. In some embodiments, the spool holder portion may be structurally configured to engage the engagement portion to support the cable spool portion in the spool holder portion.

Various aspects of the system, as well as other embodiments, objects, features and advantages of this disclosure, will be apparent from the following detailed description of illustrative embodiments thereof, which is to be read in conjunction with the accompanying drawings.

### BRIEF DESCRIPTION OF THE DRAWINGS

The accompanying drawings, which are incorporated in and constitute a part of this specification, illustrate embodiments of the present teachings and together with the description, serve to explain the principles of the present teachings.

FIG. 1 is a perspective view of an example modular fiber patching system in accordance with various aspects of the disclosure.

FIG. 2 is a top perspective view of an example fiber management portion of the patching system of FIG. 1.

FIG. 3 is a bottom perspective view of the fiber management portion of FIG. 2.

FIG. 4 is a perspective view of an example spool assembly of the patching system of FIG. 1.

FIG. 5 is an exploded view of the spool assembly of FIG. 4.

FIG. 6 section view of the spool assembly of FIG. 4 taken along the 6-6 line.

FIG. 7 section view of the spool assembly of FIG. 4 taken along the 7-7 line.

FIG. 8 is a perspective view of an example module holder and patching module of the system of FIG. 1.

FIG. 9 is a perspective view of patching module of FIG. 8.

FIG. 10 is a perspective view of an example patching module of the system of FIG. 1.

FIG. 11 is a perspective view of the fiber management portion of FIG. 2 with mounting portions.

FIG. 12 is a perspective view of an example modular fiber patching system in accordance with various aspects of the disclosure.

FIG. 13 is a top perspective view of an example fiber management portion of the patching system of FIG. 12.

FIG. 14 is a bottom perspective view of the fiber management portion of FIG. 13.

FIG. 15 is an exploded view of the spool assembly of the patching system of FIG. 12.

FIG. 16 section view of the spool assembly of FIG. 15.

FIG. 17 section view of the spool assembly of FIG. 15.

### DETAILED DESCRIPTION

Reference will now be made in detail to embodiments and methods of the present disclosure, which constitute the best modes of practicing the present disclosure presently known to the inventors. The figures are not necessarily to scale. However, it is to be understood that the disclosed embodiments are merely exemplary of the present disclosure that may be embodied in various and alternative forms. Therefore, specific details disclosed herein are not to be interpreted as limiting, but merely as a representative basis for any aspect of the present disclosure and/or as a representative basis for teaching one skilled in the art to variously employ the present disclosure.

It is also to be understood that this present disclosure is not limited to the specific embodiments and methods described below, as specific components and/or conditions may, of course, vary. Furthermore, the terminology used herein is used only for the purpose of describing particular embodiments of the present disclosure and is not intended to be limiting in any way.

It must also be noted that, as used in the specification and the appended claims, the singular form “a,” “an,” and “the” comprise plural referents unless the context clearly indicates otherwise. For example, reference to a component in the singular is intended to comprise a plurality of components.

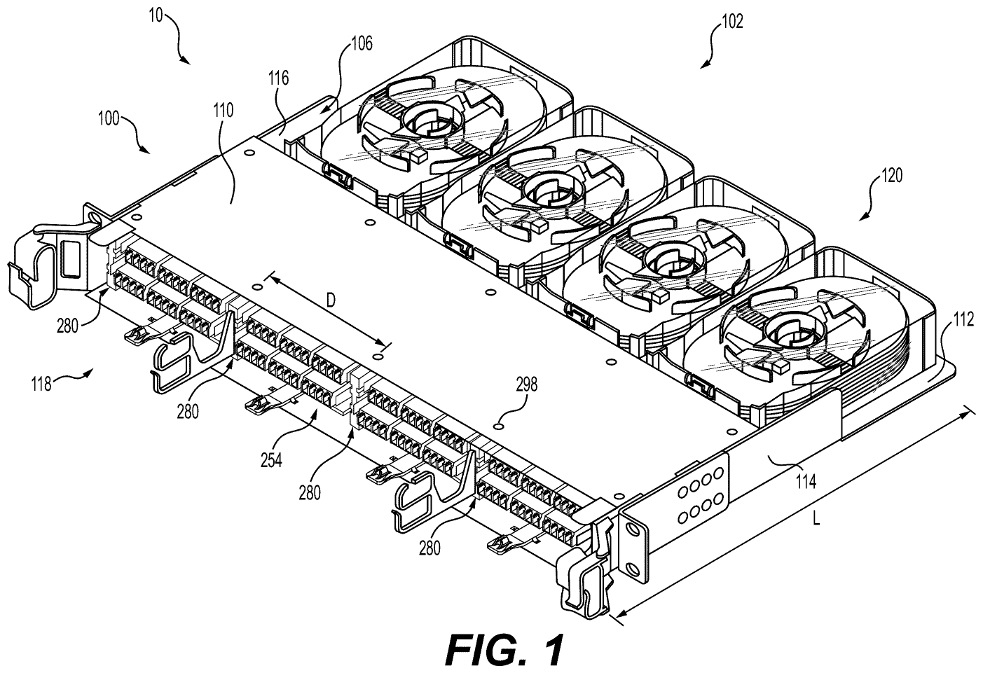

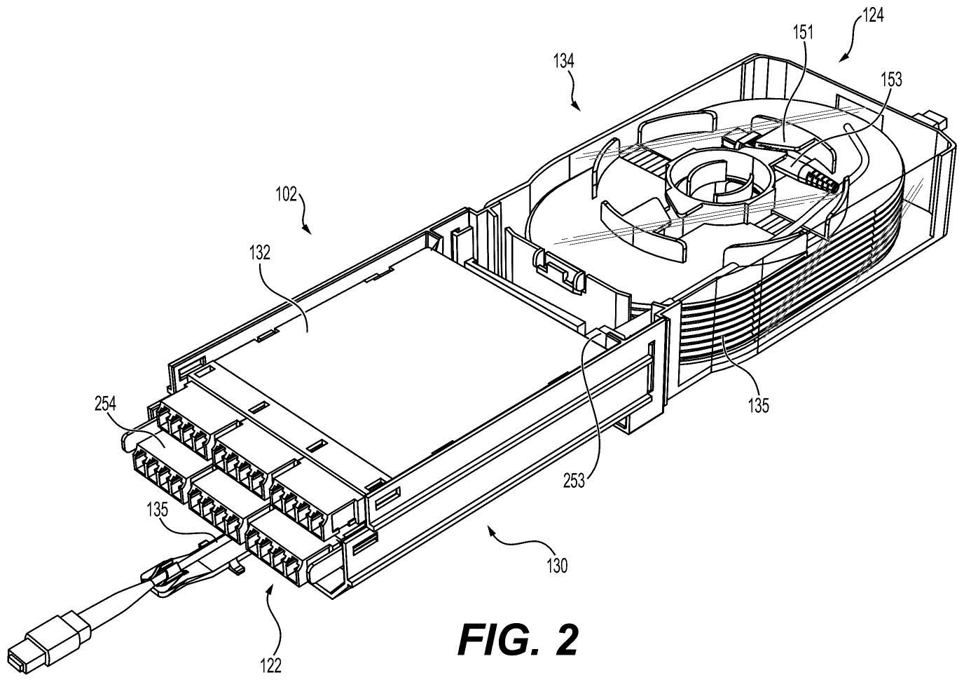

Embodiments of the disclosure provide a modular fiber cable patching system 10. FIG. 1 shows an example modular fiber cable patching system 10 in accordance with embodiments of the disclosure. The example modular fiber cable patching system 10 may include a base portion or chassis 100 and a fiber management portion 102, for example, a fiber management arrangement, structurally configured to include a holding portion 130 and a storage portion 134 (FIG. 2). In some aspects, the fiber management portion 102 may comprise a plurality of fiber management portions.

In the illustrated embodiment of FIG. 1, a base portion 100 may be structurally configured to receive and support a plurality of fiber management portions 102. In some embodiments, each of the fiber management portions 102 may be selectively removable from the base portion 100 as desired. In the illustrated implementation, the base portion 100 may be structurally configured to receive and support the plurality of fiber management portions in a side-by-side arrangement. In other implementations, however, the base portion 100 may be structurally configured to receive and support the plurality of fiber management portions other than in a side-by-side arrangement (e.g., a stacked arrangement). In the illustrated implementation, the base portion 100 may be structurally configured to receive and support four fiber management portions 102. In other implementations, the base portion 100 may be structurally configured to receive and support more or less than four fiber management portions 102.

The base portion 100 may be configured in a variety of ways. In some implementations, the base portion 100 may form a chassis or housing having a length L and an interior space 106 into which the fiber management portion 102 may be received. In some implementations, the base portion 100 may include a top wall portion 110, a bottom wall portion 112 opposite the top wall portion 110, a first side wall portion 114 extending between the top wall portion 110 and the bottom wall portion 112, and a second side wall portion 116 opposite the first side wall portion 114 and extending between the top wall portion 110 and the bottom wall portion 112. The base portion 100

implementations, the bottom wall portion 112 may extend the length L of the base portion 100 while the top wall portion 110 may be a partial wall that extends less than the length L (e.g., 40-60% the length L of the base portion 100).

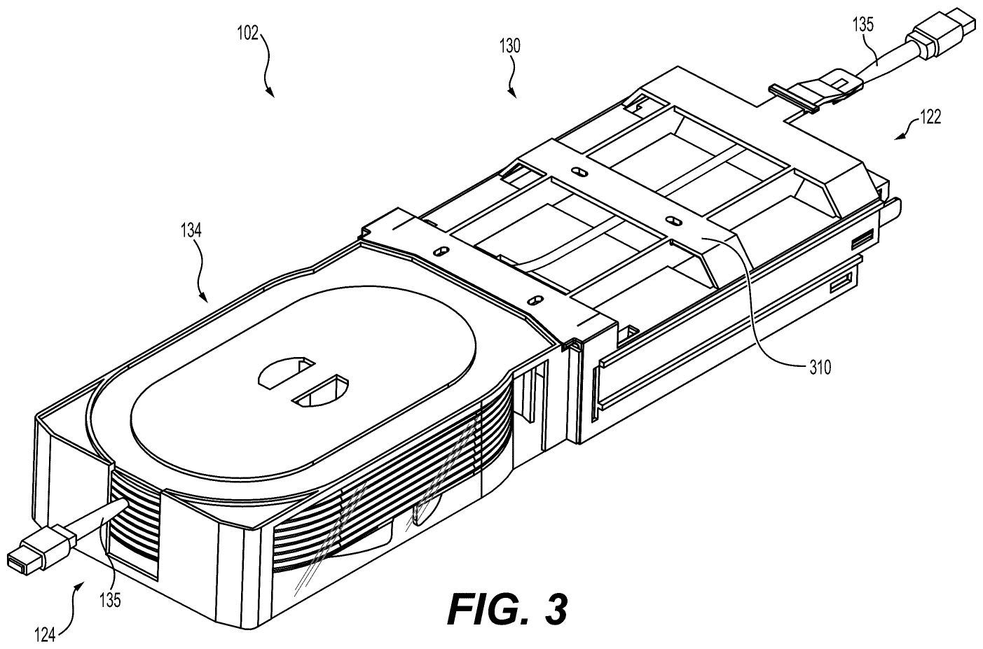

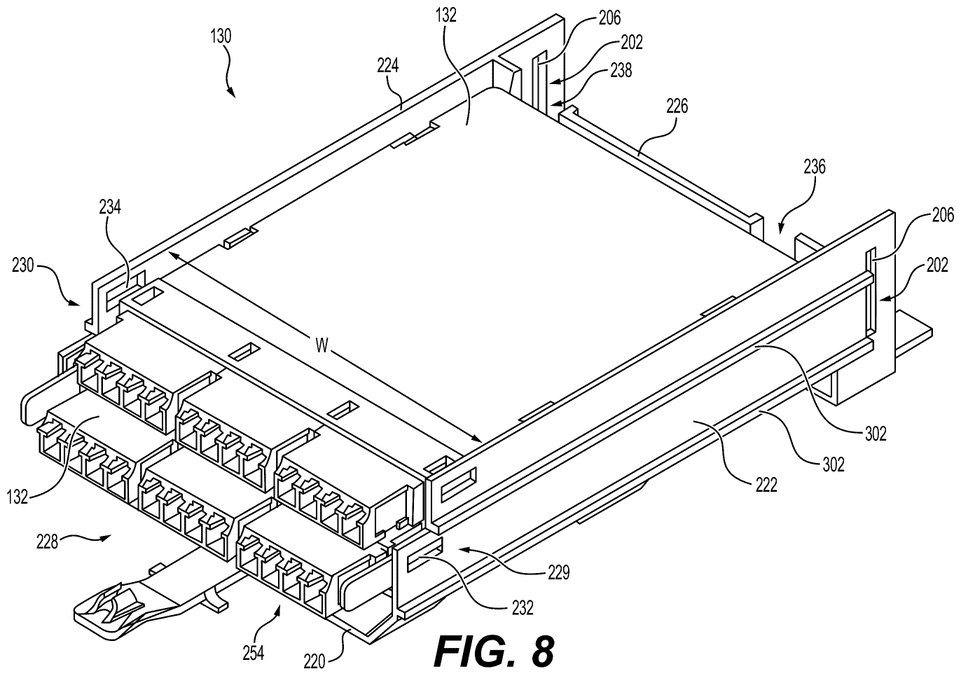

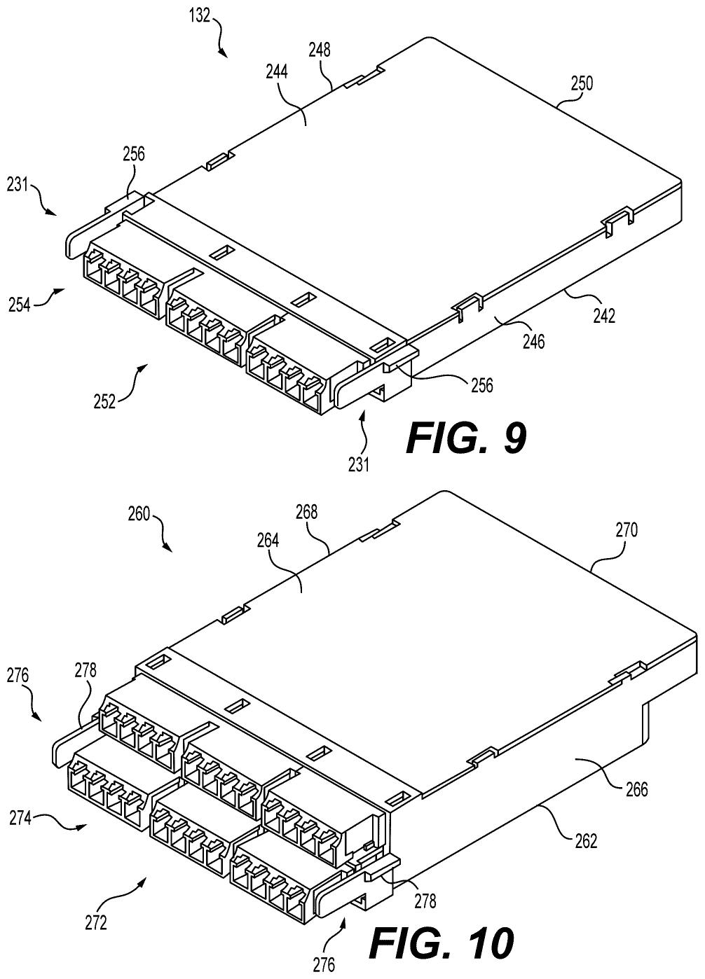

In some implementations, each of the plurality of fiber management portions 102 may be structurally configured the same as the other fiber management portions. In other implementations, however, some of the fiber management portions 102 may have different configurations. Referring to FIGS. 2-3, the fiber management portion 102 may include a front portion 122 and a back portion 124 opposite the front portion 122. In some implementations, the holding portion 130 may be configured to receive and hold a patching portion 132 (see FIGS. 8 and 9), for example, a patching module or a patching cassette.

The storage portion 134 may be structurally configured to store a length of cable 135 (e.g., multi-strand fiber cable). For example, the storage portion 134 may include a spool that is structurally configured to store an excess length of cable that is not needed for a specific installation. In some implementations, the storage portion 134 may be structurally configured to store 100 feet of 12F multifiber optical cable or 50 feet of 24F multifiber optical cable. Such multifiber cables may be terminated with a multifiber push-on (MPO) connector, for example. The storage portion 134 may be configured in a variety of ways. In some implementations, the fiber management portion 102 may be structurally configured so that the cable 135 can enter the fiber management portion 102 from the front portion 122 or from the back portion 124. For illustrative purposes, FIGS. 2-3 illustrate the cable 135 entering from both the front portion 122 and the back portion 124. In practice, however, the cable 135 would typically enter the fiber management portion 102 in either the front portion 122 or the back portion 124 since the other end of the cable 135 is connected to the one or more patching modules.

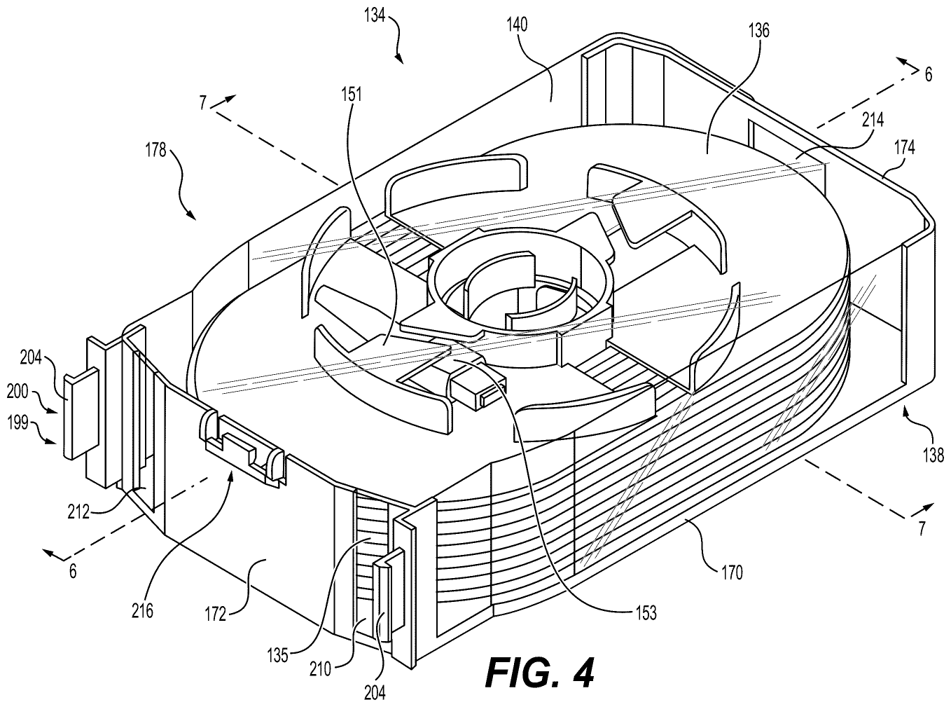

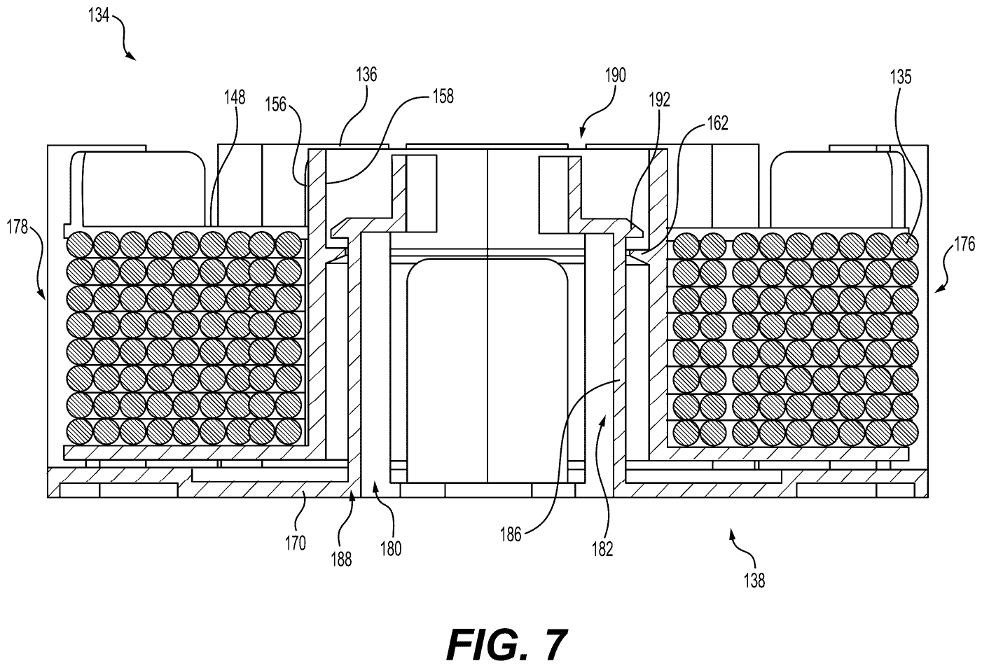

Referring to FIGS. 4-7, in some implementations, the storage portion 134 may include a cable spool portion 136, a spool holder portion 138, and an optional cover or cover portion 140. The cable spool portion 136 can be configured in a variety of ways. In some implementations, the cable spool portion 136 may include a top portion 142 and a bottom portion 144 spaced apart from the top portion 142 by an intermediate portion 146 extending between the top portion 142 and the bottom portion 144. The top portion 142 may include a top surface 148 and a bottom surface 150 opposite the top surface 148. In some implementations, the top surface 148 may include a cable management portion 151 structurally configured to secure a portion of the cable 135 and/or a connector 153 (FIG. 2). For illustrative purposes, FIGS. 1-2, 4, and 6 show the connector 153 retained by the cable management portion 151 and unattached to the cable 135. The cable management portion 151, however, may retain the cable 135 and connector 153, attached to the cable 135, when the cable 135 is in a stored condition. The bottom portion 144 may include a top surface 152 and a bottom surface 154 opposite the top surface 152. In some implementations, the top surfaces 148, 152 and the bottom surfaces 150, 154 of the top portion 142 and the bottom portion 144 may be parallel to each other.

In some implementations, the intermediate portion 146 may include an outer surface 156 and an inner surface 158. In the illustrated implementation, the outer surface 156, the top portion 142, and the bottom portion 144 may have oval-shaped profiles. The outer surface 156 may define the perimeter around which the cable 135 may be wound on the cable spool portion 136. In some implementations, the oval-shaped profile, as compared to a comparable circular profile, may allow the cable spool portion 136 to hold more cable 135 (e.g., 30%-40% more). The inner surface 158 may define a passage 160 extending through the cable spool portion 136 from the top portion 142 to the bottom portion 144. In some implementations, the inner surface 158 may be tubular such that the passage 160 has a generally round cross section.

In some implementations, the cable spool portion 136 may include an engagement portion 162 structurally configured to interact with the spool holder portion 138 to secure the cable spool portion 136 onto the spool holder portion 138. The engagement portion 162 can be configured in a variety of ways, including different structure, location, orientation, etc.

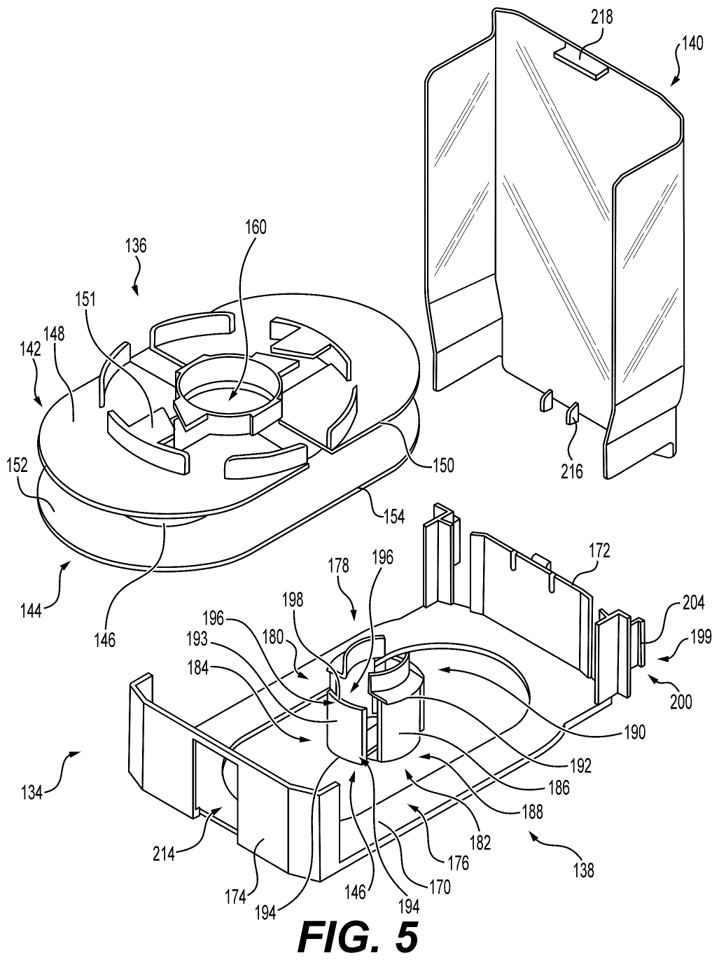

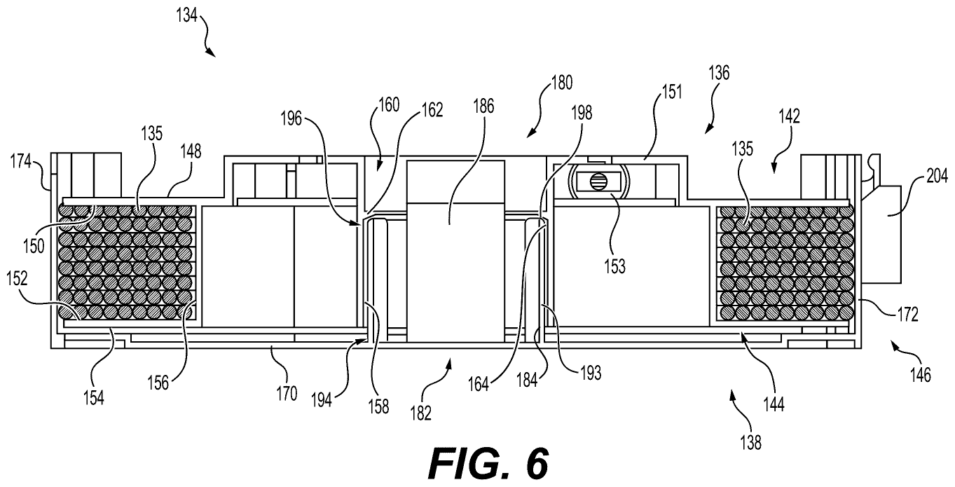

In some implementations, the engagement portion 162 may be formed as an annular ridge protruding from the inner surface 158 of the intermediate portion 146. In some implementations, the cable spool portion 136 may be structurally configured to facilitate rotation of the cable spool portion 136 relative to the spool holder portion 138. For example, in some implementations, the cable spool portion 136 may include a spool holder engaging surface 164. In some implementations, the spool holder engaging surface 164 may be structurally configured to include a downward-facing tapered or chamfered surface structurally configured to engage a cable spool engaging surface 198 (FIGS. 5-6) on the spool holder portion 138. In some implementations, the spool holder engaging surface 164 may be positioned on the engagement portion 162.

The spool holder portion 138 may be structurally configured to store the cable spool portion 136 and associated cable 135 on the cable spool portion 136 in a manner that allows for the cable spool portion 136 to be removed from the spool holder portion 138 as desired. The spool holder portion 138 can be configured in a variety of ways. In some implementations, the spool holder portion 138 may include a bottom wall portion 170, a front wall portion 172 extending from the bottom wall portion 170, a back wall portion 174 opposite the front wall portion 172 and extending from the bottom wall portion 170, a first side portion 176, and a second side portion 178 opposite the first side portion 176. In some implementations, the first side portion 176 and/or the second side portion 178 may be open, or at least partially open. For example, the first side portion 176 and the second side portion 178 may be at least partially open to facilitate rotation of the cable spool portion 136 within and relative to the spool holder portion 138.

In some implementations, the spool holder portion 138 may include a mounting portion 180 structurally configured to mount the cable spool portion 136 on the spool holder portion 138. In some implementations, the mounting portion 180 may include a retaining portion 182 structurally configured to move between a secure position in which the retaining portion secures the cable spool portion to the spool holder portion and a release position in which the cable spool portion may be easily removed from the spool holder portion 138 when desired. In some implementations, the mounting portion 180 can include a support portion 184 structurally configured to support the cable spool portion 136 within the spool holder portion 138 while allowing for rotation of the cable spool portion 136 relative to the spool holder portion 138.

The retaining portion 182 can be configured in a variety of ways. In some implementations, the retaining portion 182 may be structurally configured to engage the engagement portion 162. In some implementations, the retaining portion 182 may include a pair of flexible portions 186 (e.g., arms) extending upward from the bottom wall portion 170. In other implementations, the retaining portion 182 may include more or less than a pair of flexible portion 186.

Each of the flexible portions 186 may include a proximal portion 188 attached to the bottom wall portion 170 and a distal portion 190 opposite the proximal portion 188. In some implementations, the flexible portions 186 may have a curved cross-sectional profile that is complementary to the circular cross section of the inner surface 158. In some implementations, each of the pair of flexible portions 186 may include a projecting portion 192 (e.g., projection or ridge) structurally configured to engage the engagement portion 162 to retain the cable spool portion 136 on the spool holder portion 138.

The support portion 184 can be configured in a variety of ways. In some implementations, the support portion 184 may include one or more projections (e.g., a pair of spaced apart projections) having a proximal portion 194 attached to the bottom wall portion 170 and a distal portion 196 structurally configured to engage the engagement portion 162 of the cable spool portion 136 to support the cable spool portion 136 within the spool holder portion 138. In some implementations, the cable spool engaging surface 198 may be an upward-facing tapered or chamfered surface structurally configured to engage the spool holder engaging surface 164.

The cable spool portion 136 can be installed onto the spool holder portion 138 by placing the cable spool portion 136 over the mounting portion 180 such that the retaining portion 182 and the support portion 184 are received within the passage 160. As the cable spool portion 136 is moved onto the mounting portion 180, the projecting portion 192 may engage the engagement portion 162 causing the flexible portions 186 to flex inward and allow the projecting portion 192 to pass by the engagement portion 162. Once the projecting portion 192 has passed by the engagement portion 162, the flexible portions 186 may flex back outward such that the projecting portion 192 may be radially beneath the engagement portion 162. As a result, the cable spool portion 136 may be blocked from being removed from the mounting portion 180.

Further downward movement of the cable spool portion 136 relative to the mounting portion 180 may be limited by engagement between the engagement portion 162 and the support portion 184 while allowing rotational movement of the cable spool portion 136 relative to the mounting portion 180. In some implementations, rotational movement may be further supported by both the spool holder engaging surface 164 and the cable spool engaging surface 198 being chamfered.

The cable spool portion 136 may be easily removed from the spool holder portion 138 by manually flexing the flexible portion 186 inward toward each other to move the projecting portion 192 from beneath the engagement portion 162. As shown in FIG. 5, the pair of flexible portion 186 may be arranged opposite each other (e.g., 180 degrees apart). In some implementations, the distal portions 190 of the flexible portions 186 may be configured to be manually engaged. For example, in some implementations, the distal portions 190 may be offset radially inward to provide additional spacing for an individual to engage the distal portions 190. In some implementations, the distal portions 190 of the flexible portions 186 can be pinched toward each other with a single hand allowing the cable spool portion 136 to be removed from the spool holder portion 138.

In some implementations, the spool holder portion 138 may be structurally configured to attach to the holding portion 130. The spool holder portion 138 can be structurally configured to attach to the holding portion 130 in a variety of ways. In some implementations, the spool holder portion 138 may be structurally configured to be releasably attached to the holding portion 130 via an attachment portion 199. In some implementations, the attachment portion 199 may include a first attachment portion 200 associated with the spool holder portion 138 and a second attachment portion 202 associated with the holding portion 130. In some implementations, the first attachment portion 200 may be structurally configured to connect with a corresponding second attachment portion 202. The first attachment portion 200 and the second attachment portion 202 may be structurally configured to attach in any suitable manner (e.g., snap connection, friction fit, etc.). In the illustrated implementation, the first attachment portion 200 may include a pair of flex portions 204 (e.g., flex clips) that extends from, or are adjacent to, the front wall portion 172 at opposite sides of the spool holder portion 138 and the second attachment portion 202 may include a pair of receiving portions 206 (e.g., openings), each of which may be structurally configured to receive a corresponding one of the pair of flex portions 204.

In some implementations, the spool holder portion 138 may be structurally configured to facilitate routing the cable 135 from the cable spool portion 136 to locations exterior to the spool holder portion 138. For example, in some implementations, the wall of the spool holder portion 138 may include one or more openings through which the cable 135 can be routed. In the illustrated implementation, the front wall portion 172 may include a first opening or slot 210 near or adjacent the first side portion 176 and a second opening or slot 212 near or adjacent the second side portion 178 to allow the cable 135 from the cable spool portion 136 to exit the spool holder portion 138 from the front adjacent either side portions 176, 178. Further, in some implementations, the back wall portion 174 may include a third opening or slot 214 through which cable 135 from the cable spool portion 136 may exit the spool holder portion 138 from the back of the spool holder portion 138.

The cover portion 140 may be structurally configured to cover the cable spool portion 136 when the cable spool portion 136 is received in the spool holder portion 138. The cover portion 140 can be configured in a variety of ways. In some implementations, the cover portion 140 may be structurally configured to attach to the spool holder portion 138 and pivot between an open position (FIG. 5) and a closed position (FIG. 4). For example, the cover portion 140 may be connected to the spool holder portion 138 by a pivot connection 216 (e.g., hinge, joint, elbow, etc.) (FIG. 5). In some implementations, the cover portion 140 may include a latching mechanism 218 (e.g., latch, catch, clasp, detent, etc.) structurally configured to engage the spool holder portion 138 to retain the cover portion 140 in the closed position.

Referring to FIGS. 8-10, the holding portion 130 may be structurally configured to support the patching portion 132 in a manner that allows the patching portion 132 to be easily attached to and released from the holding portion 130. The patching portion 132 may include one or more patching portions 132. The holding portion 130 can be configured in a variety of ways. In some implementations, the holding portion 130 may include a bottom wall portion 220, a first side wall portion 222 extending from the bottom wall portion 220, a second side wall portion 224 opposite the first side wall portion 222 and extending from the bottom wall portion 220, a back wall portion 226 extending between the first side wall portion 222 and the second side wall portion 224, and a front portion 228 opposite the back wall portion 226. In some implementations, the front portion 228 may at least be partially open. In some implementations, the second attachment portion 202 may be positioned at, or adjacent, the back wall portion 226.

As shown in FIG. 8, the patching portion 132 may be received between the first side wall portion 222 and the second side wall portion 224 adjacent the bottom wall portion 220 (e.g., slide into place via the open front portion 228). The holding portion 130 may be structurally configured to support the patching portion 132 in a variety of ways. In some implementations the holding portion 130 may attach to the patching portion 132 via an attachment portion 229.

In some implementations, the attachment portion 229 may include a holder attachment portion 230 (FIG. 8) associated with the holding portion 130 and patching attachment portion 231 (FIG. 9) associated with the patching portion 132. In some implementations, the holder attachment portion 230 may be structurally configured to engage the patching attachment portion 231 (FIG. 9) to attach the patching portion 132 to the holding portion 130. The holder attachment portion 230 may comprise one or more holder attachment portions 230, and the patching attachment portion 231 may comprise one or more patching attachment portions 231. The holder attachment portion 230 and the patching attachment portion 231 may be configured to attach in any suitable manner (e.g., snap connection, friction fit, etc.).

In some implementations, the holder attachment portion 230 may include a first pair of openings 232 (e.g., slots) positioned opposite each other on the first side wall portion 222 and the second side wall portion 224, respectively. In some implementations, the holder attachment portion 230 may include a second pair of openings 234 (e.g., slots) positioned opposite each other on the first side wall portion 222 and the second side wall portion 224, respectively. In some implementations, the first pair of openings 232 may be structurally configured to attach a first patching portion 132 to the holding portion 130 and the second pair of openings 234 may be structurally configured to attach a second patching portion 132 to the holding portion 130.

In some implementations, the holding portion 130 may include one or more openings for routing cable to the one or more patching portions 132. In some implementations, for example, the back wall portion 226 of the holding portion 130 may include a first opening or slot 236 near or adjacent the first side wall portion 222 and a second opening or slot 238 near or adjacent the second side wall portion 224 to allow the cable 135 to be connected to the one or more patching portions 132.

Referring to FIG. 9, an example patching portion 132 is illustrated. The patching portion 132 may be structurally configured to receive the cable 135 (e.g., multiple strand fiber cable) and then separate the cable 135 into individual strands or pairs of strands that can be connected to various devices within a fiber optic network. In some implementations, the patching portion 132 may receive and separate the strands in a conventional manner.

The patching portion 132 can be configured in a variety of ways. In some implementations, the patching portion 132 may have a generally cuboid or box-like configuration. For example, in the illustrated implementation on FIG. 9, the patching portion 132 may include a bottom wall portion 242, a top wall portion 244 opposite the bottom wall portion 242, a first side wall portion 246 extending between the bottom wall portion 242 and the top wall portion 244, a second side wall portion 248 opposite the first side wall portion 246 and extending between the bottom wall portion 242 and the top wall portion 244, a back wall portion 250 extending between the first side wall portion 246 and the second side wall portion 248, and a front portion 252 opposite the back wall portion 250.

In some implementations, the patching portion 132 may include one or more input connectors 253 (FIG. 2) for operably connecting to the cable 135. The input connectors 253 can be any suitable type of connector, such as for example, a multi-fiber push-on (MPO) type connector. In some implementations, the input connectors 253 may be positioned on the back wall portion 250 of the patching portion 132.

The front portion 252 may be structurally configured to have an adapter portion 254 for connecting to each of the separated strands or pairs of strands. The adapter portion 254 may comprise one or more adapter portions. The adapter portion 254 can be configured in a variety of ways, such as for example, the type of receptacles/ports, the number of receptacles/ports, and the arrangement and/or orientation of the receptacles/ports. In some implementations, the receptacles/ports can include LC type receptacles or ports. In some implementations, the adapter portion 254 may include a plurality of output adapters arranged side-by-side across a width of the patching portion 132 (i.e., extending between the first side wall portion 246 and the second side wall portion 248).

In some implementations, the patching portion 132 may be configured for 12F cable. For example, in some implementations, the input connector 253 may be structurally configured to receive a 12F cable (e.g., a 12F MPO connector) and the front portion 252 can be structurally configured to include 12 output ports (e.g., 12 LC connectors). As shown in FIG. 8, each holding portion 130 can include more than one patching portion 132. For example, in the illustrated implementation, the holding portion 130 may include a first and a second 12F patching portion 132. In some implementations, the first and the second patching portion 132 can be in a stacked arrangement with the patching portion on top being partially offset toward the back wall portion 226 of the holding portion 130 from the patching portion on the bottom. In some implementations, the first and the second patching portion 132 can be a single monolithic structure of unitary construction, and other implementations, the first and the second patching portion 132 can be separate structures that may or may not be coupled to one another.

The one or more patching attachment portions 231 may be structurally configured to engage with the one or more holder attachment portions 230 to secure the patching portion 132 to the holding portion 130. The one or more patching attachment portions 231 can be configured in a variety of ways. In some implementations, the one or more patching attachment portions 231 may include a pair of flex portions 256 (e.g., flex clips) structurally configured to be received in the first pair of openings 232 or second pair of openings 234 on the holding portion 130. In some implementations, the pair of flex portions 256 may be positioned adjacent to and on opposite sides of the front portion 252.

In some implementations, both the spool holder portion 138 and the patching portion 132 may be easily attached to and removed from the holding portion 130. For example, the spool holder portion 138 may be easily attached to the holding portion 130 by flexing the flex portions 204 toward each other as the front wall portion 172 of the spool holder portion 138 is moved into position adjacent the back wall portion 226 of the holding portion 130. Once each of the flex portions 204 is positioned to be received in a corresponding one of the receiving portions 206, the flex portions 204 may flex back outward to secure the spool holder portion 138 to the holding portion 130. The spool holder portion 138 may be removed by flexing the flex portions 204 inward and pulling the spool holder portion 138 and the holding portion 130 away from each other.

Similarly, the patching portion 132 may be easily attached to the holding portion 130 by flexing the flex portions 256 toward each other and moving the patching portion 132 into the holding portion 130 such that the back wall portion 250 of the patching portion 132 is adjacent the back wall portion 226 of the holding portion 130. Once each of the flex portions 256 is positioned to be received in a corresponding one of the openings 232, 234, the flex portions 256 may flex back outward to secure the patching portion 132 to the holding portion 130. A second patching portion 132 may be added to the holding portion 130 in a similar manner. The patching portions 132 may be removed by flexing the flex portions 256 inward and pulling, for example, the patching portion 132 from the holding portion 130.

FIG. 10 illustrates another example patching portion 260. The example patching portion 260 of FIG. 10 is substantially similar to the patching portion 132 of FIG. 9 and the description of the patching portion 132 applies equally to the patching portion 260 with the exception that the patching portion 260 is configured for 24F cable. Thus, for example, a fiber management portion 102 configured for 24F can include a pair of patching portions structurally configured for 12F cable or a single patching portion structurally configured for 24F.

The patching portion 260 may be structurally configured to receive the cable 135 (e.g., 24F cable) and then separate the cable 135 into individual strands or pairs of strands. The patching portion 260 may include a bottom wall portion 262, a top wall portion 264, a first side wall portion 266, a second side wall portion 268, a back wall portion 270, and a front portion 272. The patching portion 260 may include one or more input connectors 253 (e.g., similar to input port in FIG. 2). For example, in some implementations, the patching portion 260 may include a 24F MPO type input port positioned on the back wall portion 270 of the patching portion 260.

The front portion 272 may be structurally configured to have a plurality of output connectors or ports/receptacles 274 for connecting to each of the separated strands or pairs of strands. For example, in some implementations, the plurality of output connectors 274 may include twenty-four LC type connectors and arranged in two rows, side-by-side across a width of the patching portion 260.

In some implementations, the patching portion 260 may include one more patching attachment portions 276 structurally configured to engage with the one or more holder attachment portions 230 (FIG. 8) to secure the patching portion 260 to the holding portion 130. In some implementations, the one or more patching attachment portions 276 may include a pair of flex portions 278 (e.g., flex clips) structurally configured to be received in the first pair of openings 232 on the holding portion 130.

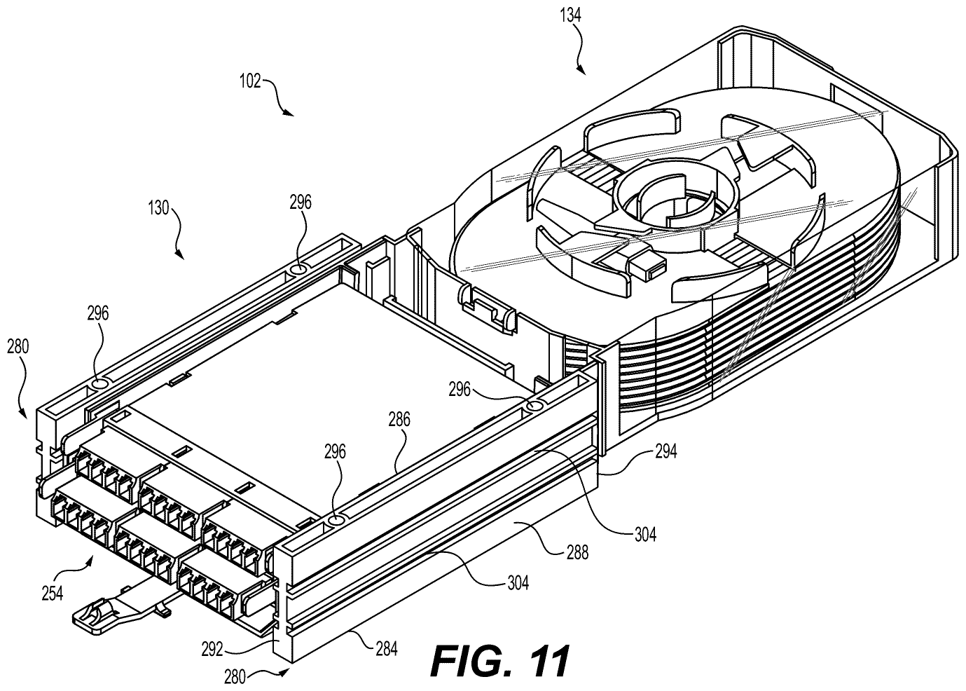

Referring to FIGS. 1 and 11, in some implementations, the base portion 100 may be structurally configured to receive and support a plurality of fiber management portions 102 in a side-by-side arrangement. In some implementations, the base portion 100 may include a plurality of mounting portions 280. The mounting portions 280 may be configured in a variety of ways. In some implementations, the mounting portions 280 may be structurally configured to be positioned between the fiber management portions 102 within the interior space 106 of the base portion 100. For example, in some implementations, the mounting portions 280 may be structurally configured as rails, walls, or partitions within the interior space 106. In some implementations, the mounting portions 280 may have a generally cuboid or board-shaped body portion 282 having a bottom surface 284, a top surface 286 opposite the bottom surface 284, a first lateral surface 288 extending between the bottom surface 284 and the top surface 286, a second lateral surface 290 opposite the first lateral surface 288 and extending between the bottom surface 284 and the top surface 286, a front surface 292 extending between the first lateral surface 288 and the second lateral surface 290, and a back surface 294 opposite the front surface 292 and extending between the first lateral surface 288 and the second lateral surface 290.

In some implementations, the mounting portions 280 may be structurally configured to be fixedly attached within the interior space 106. The mounting portions 280 may be attached in a variety of ways. In some implementations, the mounting portions 280 may include attachment portions 296 structurally configured to receive fasteners 298 (e.g., screws, bolts, etc.) (FIG. 1). In some implementations, the attachment portions 296 may be positioned on the bottom surface 284 and/or the top surface 286. The mounting portions 280 may be positioned in the interior space 106 such that the top surface 286 is adjacent the top wall portion 110 of the base portion 100 and the bottom surface 284 is adjacent the bottom wall portion 112 of the base portion 100. The fasteners 298 may then be inserted through the top wall portion 110 and/or bottom wall portion 112 and into respective attachment portions 296.

The mounting portions 280 may be spaced apart in the interior space 106 a distance D (FIG. 1) slightly larger than a width W (FIG. 8) of the holding portion 130 such that the holding portion 130 may be received into the interior space 106 between two mounting portions 280. In some implementations, the mounting portion 280 and the holding portion 130 may have cooperating structure configured to align and support the holding portion 130 between the mounting portions 280. For example, in some implementations, the holding portion 130 and the mounting portion 280 may have cooperating tongue-and-groove arrangements.

In the illustrated implementation, for example, the holding portion 130 may have ridges 302 (FIG. 8) extending from the front portion 228 toward the back wall portion 226 along each of the first side wall portion 222 and second side wall portion 224. Further, the mounting portions 280 may have corresponding grooves 304 extending from the front surface 292 toward the back surface 294 along the first lateral surface 288 and the second lateral surface 290. The grooves 304 may be structurally configured to receive the ridges 302 such that the holding portion 130 can easily slide into the interior space 106 and be supported in place between the mounting portions 280, as shown in FIG. 11. In some implementations, the fiber management portion 102 can be slid into the interior space 106 from the open front side portion 118 of the base portion 100 and/or from the open rear side portion 120 of the base portion 100.

In some implementations, the fiber management portion 102 may be used as a standalone device separate from the base portion 100. For example, the fiber management portion 102 may be structurally configured to be easily removed from and attached to the base portion 100 and function independent of the base portion 100. In some implementations, the fiber management portion 102 may include a mounting portion 310 (FIG. 3) (e.g., bracket, mounting apertures, etc.) for mounting the fiber management portion 102 to a structure (e.g., wall, pole, etc.).

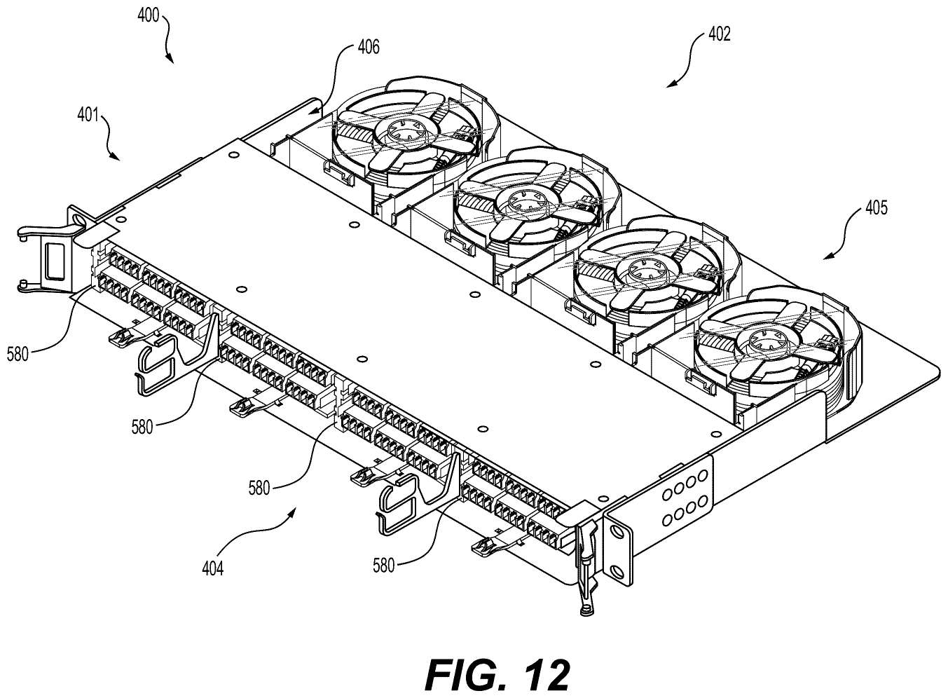

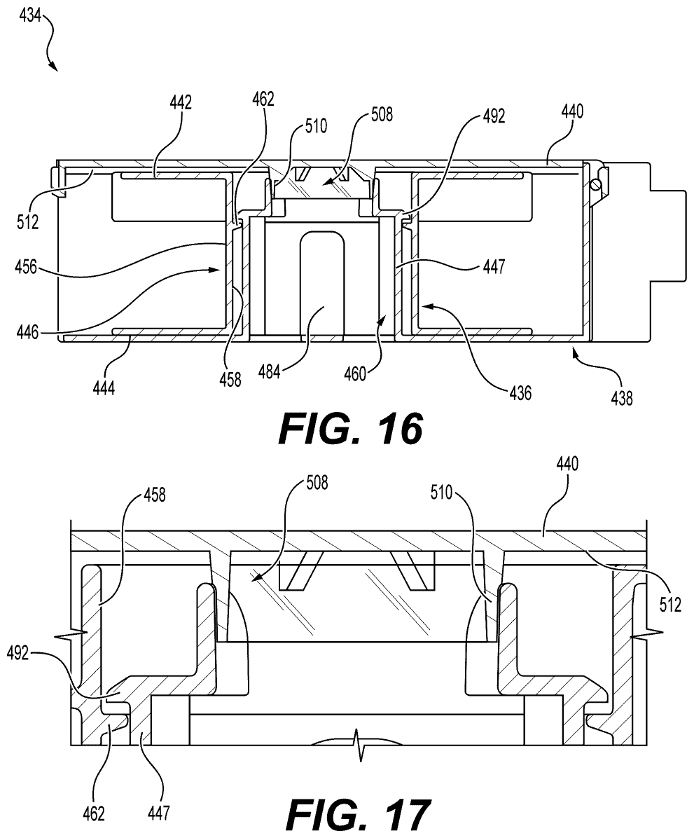

FIGS. 12-17 illustrate an example modular fiber cable patching system 400 in accordance with embodiments of the disclosure. The modular fiber cable patching system 400 may be substantially the same or similar to the modular fiber cable patching system 10 of FIGS. 1-11 and the description of the modular fiber cable patching system 10 applies equally to the modular fiber cable patching system 400.

For example, the modular fiber cable patching system 400 may include a base portion 401 and a fiber management portion 402, or fiber management arrangement. The base portion 401 may be structurally configured to receive and support the fiber management portion 402, which may include a plurality of fiber management portions or arrangements 402 being selectively removable from the base portion 401 as desired. The base portion 401 may be configured in a variety of ways. In some implementations, the base portion 401 may form a chassis or housing having a front portion 404, a back portion 405, and an interior space 406 into which the fiber management portion 402 is received. In some implementations, the fiber management portion 402 may be received into the interior space 406 from the front portion 404 and/or the back portion 405.

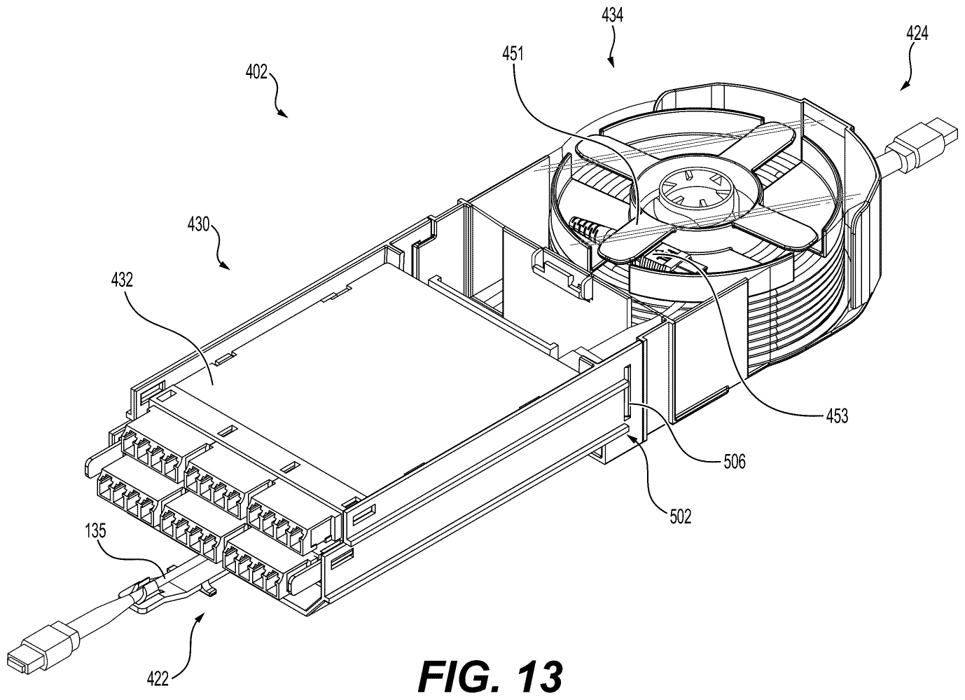

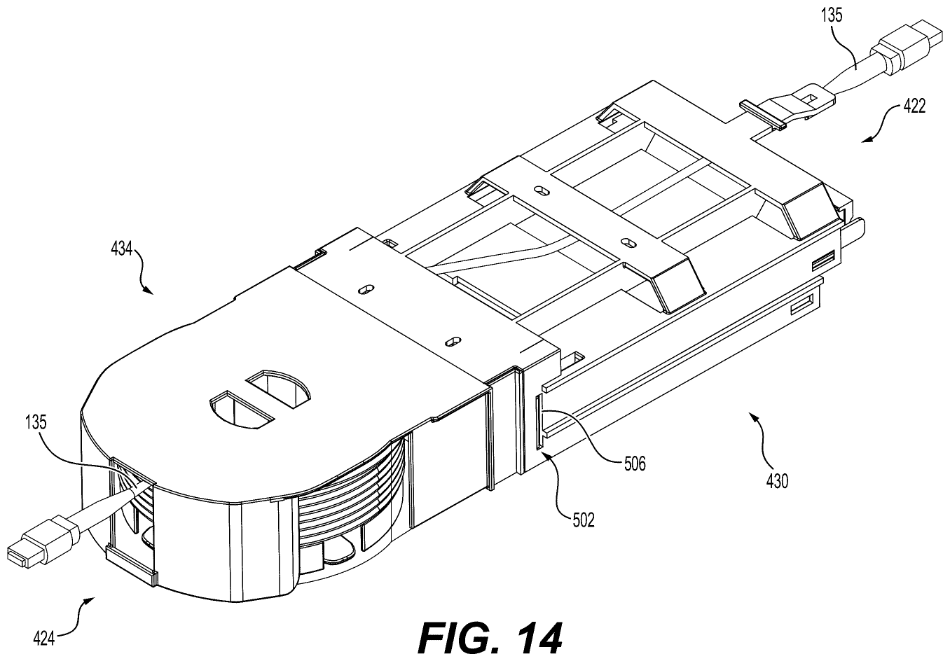

Referring to FIGS. 13-14, in some implementations, the fiber management portion 402 may include a holding portion 430, a patching portion 432, and a storage portion 434. In the illustrated implementations, the holding portion 430 and the one or more patching portions 432 may be the same as the holding portion 130 and the one or more patching portions 132 of the example of FIGS. 1-11. In other implementations, however, the holding portion 430 and the one or more patching portions 432 may differ from the holding portion 130 and the one or more patching portions 132.

The storage portion 434 (e.g., spool portion and spool holder portion) may be structurally configured to store a length of cable 135 (e.g., multi-strand fiber cable). In some implementations, the fiber management portion 402 may be structurally configured so that the cable 135 can enter the fiber management portion 402 from a front portion 422 or from a back portion 424. For illustrative purposes, FIGS. 13-14 illustrate the cable 135 entering from both the front portion 422 and the back portion 424. In practice, however, the cable 135 would typically enter the fiber management portion 402 from either the front portion 422 or the back portion 424 since the other end of the cable 135 is connected to the patching portion 432.

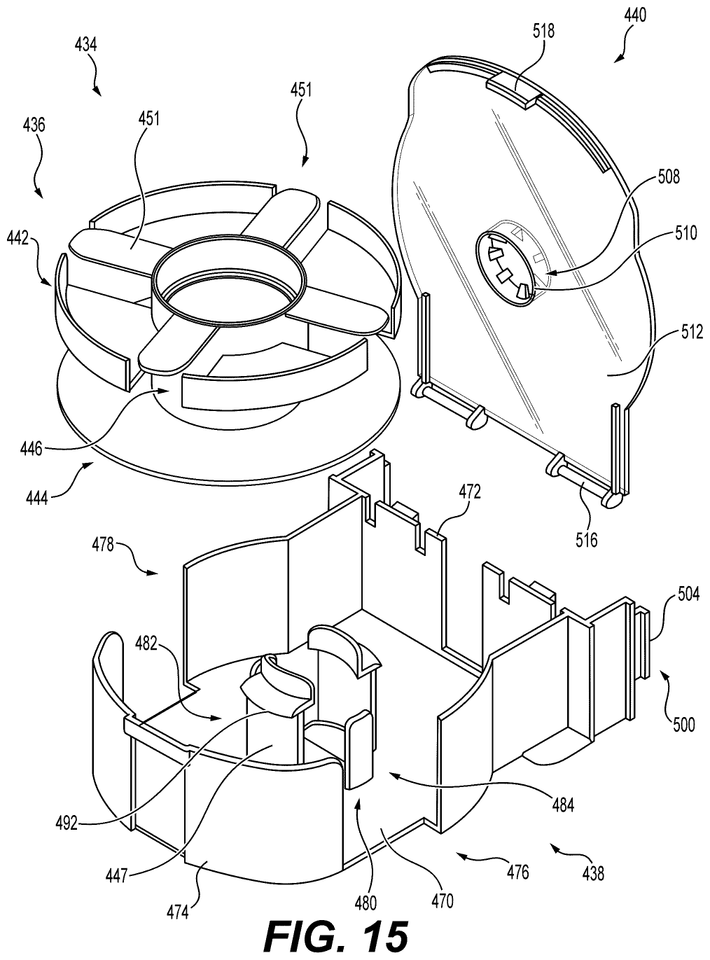

Referring to FIGS. 15-17, in some implementations, the storage portion 434 may include a cable spool portion 436, a spool holder portion 438, and an optional cover portion or cover 440. The cable spool portion 436 may be configured in a variety of ways. In some implementations, the cable spool portion 436 may include a top portion 442, a bottom portion 444, and an intermediate portion 446 extending between the top portion 442 and the bottom portion 444. The top portion 442 may include a cable management portion 451 structurally configured to secure a portion of the cable 135 and/or a connector 453.

The intermediate portion 446 may include an outer surface 456 and an inner surface 458. In the illustrated implementation, the outer surface 456, the top portion 442, and the bottom portion 444 may have a circular-shaped profile. The outer surface 456 may define the perimeter around which the cable 135 is wound on the cable spool portion 436. The inner surface 458 may define a passage 460 extending through the cable spool portion 436.

In some implementations, the cable spool portion 436 may include an engagement portion 462 structurally configured to interact with the spool holder portion 438 to secure the cable spool portion 436 onto the spool holder portion 438. In some implementations, the engagement portion 462 may be formed as an annular ridge protruding from the inner surface 458 of the intermediate portion 446. The spool holder portion 438 may be structurally configured to store the cable spool portion 436 and associated cable 135 on the cable spool portion 436 in a manner that allows for the cable spool portion 436 to be removed from the spool holder portion 438 as desired.

In some implementations, the spool holder portion 438 may include a bottom wall portion 470, a front wall portion 472, a back wall portion 474, a first side portion 476, and a second side portion 478. In some implementations, the spool holder portion 438 may include a mounting portion 480 structurally configured to mount the cable spool portion 436 to the spool holder portion 438. In some implementations, the mounting portion 480 may include a retaining portion 482 structurally configured to secure the cable spool portion 436 to the spool holder portion 438 and allow for the cable spool portion 436 to be easily removed from the spool holder portion 438 when desired. In some implementations, the mounting portion 480 may include a support portion 484 structurally configured to support the cable spool portion 436 within the spool holder portion 438 while allowing for rotation of the cable spool portion 436 relative to the spool holder portion 438.

The retaining portion 482 may be configured in a variety of ways. In some implementations, the retaining portion 482 may include a pair of flexible portions 447 (e.g., arms) extending upward from the bottom wall portion 470. In some implementations, each of the pair of flexible portions 486 may include a projection or ridge 492 structurally configured to engage the engagement portion 462 to retain the cable spool portion 436 on the spool holder portion 438. The cable spool portion 436 may be installed onto the spool holder portion 438 in the same manner as the cable spool portion 136 is installed onto, and removed from, the spool holder portion 138.

In some implementations, the spool holder portion 438 may be structurally configured to be releasably attached to the holding portion 430. In some implementations, the spool holder portion 438 may include a first attachment portion 500 structurally configured to connect with a corresponding second attachment portion 502 (FIGS. 13-14) on the holding portion 430. In some implementations, the first attachment portion 500 may include a pair of flex portions 504 that extends from, or adjacent to the front wall portion 472 at opposite sides of the spool holder portion 438 and the second attachment portion 502 includes a pair of openings 506, each of the pair of openings 506 structurally configured to receive a corresponding one of the pair of flex portions 504.

The cover portion 440 may be structurally configured to cover the cable spool portion 436 when the cable spool portion 436 is received in the spool holder portion 438. In some implementations, the cover portion 440 may be structurally configured to attach to the spool holder portion 438 and pivot between an open position (FIG. 15) and a closed position (FIG. 11). For example, the cover portion 440 may be connected to the spool holder portion 438 by a pivot connection 516 (e.g., hinge, joint, elbow, etc.) (FIG. 15). In some implementations, the cover portion 440 may include a latching mechanism 518 (e.g., latch, catch, clasp, detent, etc.) structurally configured to engage the spool holder portion 438 to retain the cover portion 440 in the closed position.

In some implementations, the storage portion 434 may be structurally configured to prevent undesired unreeling of some of the cable 135 from the cable spool portion 436. The storage portion 434 may be structurally configured to prevent undesired unreeling of the cable 135 in a variety of ways. In some implementations, the storage portion 434 may include a stop portion 508 structurally configured to prevent rotation of the cable spool portion 436 relative to the spool holder portion 438. For example, in some implementations, the stop portion 508 may include one or more projections 510 the extend from an inner face 512 of the cover portion 440. In some implementations, the one or more projections 510 may be a single annular projection. In other implementations, however, more than one projection may be used, and the projections may have shapes other than annular.

The one or more projections 510 may be structurally configured to engage the pair of flexible portions 447 when the cover portion 440 is closed. In particular, the one or more projections 510 may be structurally configured to engage an inner surface of the pair of flexible portions 447 to force the pair of flexible portions 447 radially outward such that the projection 492 on the flexible portions 447 may be pressed against the inner surface 458 of the intermediate portion 446. The resulting contact of the projection 492 against the inner surface 458 may prevent or lessen unwinding of the cable 135.

In some implementations, both the spool holder portion 438 and the patching portions 432 may be easily attached to and removed from the holding portion 430 in the same manner as described regarding the modular fiber cable patching system 10. In addition, the plurality of fiber management portions 402 may be easily added to and removed from the base portion 401. For example, in some implementations, the base portion 401 may include a plurality of mounting portions 580 structurally configured to be positioned between adjacent fiber management portions 402 within the interior space 406 of the base portion 100 in the same manner as described with the mounting portions 280. Thus, the holding portion 430 may easily slide into the interior space 406 and be supported in place between the mounting portions 580, as shown in FIG. 12.

While at least one example, non-limiting embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A modular fiber cable patching arrangement, comprising:
a base portion;
a fiber management portion structurally configured to be received in the base portion, wherein the fiber management portion comprises:
a holding portion structurally configured to support a patching portion, wherein the holding portion has a front portion and a back portion;
a storage portion structurally configured to store a slack portion of a fiber optic cable, wherein the storage portion has a front portion and a back portion;
a first attachment portion structurally configured to attach the front portion of the storage portion to the back portion of the holding portion and allow the storage portion to be detached from the holding portion;
a second attachment portion structurally configured to attach the patching portion to the front portion of the holding portion and allow the patching portion to be detached from the holding portion;
wherein the patching portion is structurally configured to patch an input fiber to an output fiber;
wherein the storage portion includes a spool holder portion structurally configured to mount a cable spool portion within the storage portion;
wherein the spool holder portion includes a support portion structurally configured to support the cable spool portion within the spool holder portion for rotation relative to the spool holder portion;
wherein the spool holder portion includes a retaining portion structurally configured to move between a secure position in which the retaining portion secures the cable spool portion in the spool holder portion and a release position in which the cable spool portion is permitted to be removed from the spool holder portion;
wherein the storage portion includes a cover portion attached to the spool holder portion and structurally configured to be move between an open position and a closed position to cover the cable spool portion within the spool holder portion;
wherein the cover portion includes a stop portion structurally configured to prevent rotation of the cable spool portion relative to the spool holder portion when the cover portion is in the closed position;
wherein the cable spool portion is structurally configured such that the storage portion is structurally configured to store the cable spool portion so as to enhance a storage capacity of the slack portion of the fiber optic cable in the storage portion;
wherein the front portion of the storage portion is structurally configured to detach from the back portion of the holding portion such that the holding portion and the storage portion are structurally configured to be used separately or together as a standalone arrangement so as to provide a modular fiber cable patching system; and
wherein the fiber management portion is structurally configured to slide into the base portion via an open front side of the base portion and an open rear side of the base portion so as to enhance installation of the modular fiber cable patching arrangement.

2. The modular fiber cable patching arrangement of claim 1, wherein the retaining portion includes a pair of flexible portions structurally configured to flex in order to move the retaining portion from the secure position to the release position.

3. The modular fiber cable patching arrangement of claim 1, wherein the stop portion includes a projecting portion extending from an inner face of the cover portion, wherein the projecting portion is structurally configured to flex the pair of flexible portions into engagement with the cable spool portion to prevent rotation of the cable spool portion relative to the spool holder portion.

4. The modular fiber cable patching arrangement of claim 1, wherein the spool holder portion is structurally configured to route the fiber optic cable out of the front portion and the back portion of the storage portion.

5. The modular fiber cable patching arrangement of claim 1, wherein the cable spool portion includes an engagement portion, and wherein the retaining portion is structurally configured to engage the engagement portion to prevent the cable spool portion from being removed from the spool holder portion, and wherein the support portion is structurally configured to engage the engagement portion to support the cable spool portion in the spool holder portion.

6. The modular fiber cable patching arrangement of claim 1, wherein the holding portion is structurally configured to support a plurality of patching portions.

7. A fiber management portion structurally configured to be received in a modular fiber cable patching arrangement, comprising:
a holding portion structurally configured to support a patching portion, wherein the holding portion has a front portion and a back portion;
a storage portion structurally configured store a fiber optic cable, wherein the storage portion has a front portion and a back portion;
a first attachment portion structurally configured to attach the storage portion to the holding portion and allow the storage portion to be detached from the holding portion;
a second attachment portion structurally configured to attach the patching portion to the holding portion and allow the patching portion to be detached from the holding portion;
wherein the storage portion includes a spool holder portion structurally configured to mount a cable spool portion within the storage portion;
wherein the spool holder portion is structurally configured to support the cable spool portion within the spool holder portion for rotation relative to the spool holder portion;
wherein the storage portion includes a retaining portion structurally configured to move between a secure position in which the retaining portion secures the cable spool portion in the spool holder portion and a release position in which the cable spool portion is permitted to be removed from the spool holder portion;
wherein the storage portion includes a stop portion structurally configured to prevent rotation of the cable spool portion relative to the spool holder portion; and
wherein the storage portion is structurally configured to detach from the holding portion such that the holding portion and the storage portion are structurally configured to be used separately or together as a standalone arrangement so as to provide a modular fiber cable patching system and enhance installation of the fiber management portion.

8. The fiber management portion according to claim 7, wherein the storage portion includes a cover portion attached to the spool holder portion, wherein the cover portion is structurally configured to be move between an open position and closed position to cover the cable spool portion within the spool holder portion.

9. The fiber management portion according to claim 8, wherein the stop portion is positioned on the cover portion and is structurally configured to prevent rotation of the cable spool portion relative to the spool holder portion when the cover portion is in the closed position.

10. The fiber management portion according to claim 7, wherein the cable spool portion has an oval shape and the storage portion is structurally configured to store the cable spool portion so as to enhance a storage capacity of excess length of the fiber optic cable.

11. The fiber management portion of claim 7, wherein the holding portion is structurally configured to support a pair of patching portions structurally configured for 12F cable or a single patching portion structurally configured for 24F.

12. The fiber management portion of claim 7, wherein the cable spool portion includes an engagement portion, and wherein the retaining portion is structurally configured to engage the engagement portion to prevent the cable spool portion from being removed from the spool holder portion, and wherein the spool holder portion is structurally configured to engage the engagement portion to support the cable spool portion in the spool holder portion.

13. A modular fiber cable patching arrangement, comprising:
a base portion; and
the fiber management portion of claim 7, wherein the fiber management portion is structurally configured to slide into the base portion via an open front side of the base portion and an open rear side of the base portion.

14. A fiber management portion structurally configured to be received in a modular fiber cable patching arrangement, comprising:
a fiber management portion structurally configured to be received in the base portion, wherein the fiber management portion comprises:
a holding portion structurally configured to removably receive a patching portion;
a storage portion structurally configured to store a fiber optic cable;
wherein the holding portion and a storage portion are structurally configured to be coupled with one another;
wherein the one or more patching portions are structurally configured to patch an input fiber to an output fiber;
wherein the storage portion includes a spool holder portion structurally configured to releasably mount a cable spool portion within the spool holder portion for rotation relative to the spool holder portion;
wherein the storage portion includes a cover portion attached to the spool holder portion, wherein the cover portion is structurally configured to be move between an open position and closed position to cover the cable spool portion within the spool holder portion;
wherein, when in the closed position, the cover portion is structurally configured to prevent rotation of the cable spool portion relative to the spool holder portion;
wherein the storage portion is structurally configured to detach from the holding portion such that the holding portion and the storage portion are structurally configured to be used separately or together as a standalone arrangement so as to provide a modular fiber cable patching system and enhance installation of the fiber management portion.

15. The modular fiber cable patching system according to claim 14, further comprising a first attachment portion structurally configured to attach a front portion of the storage portion to a back portion of the holding portion and allow the storage portion to be detached from the holding portion.

16. The modular fiber cable patching system according to claim 14, further comprising a second attachment portion structurally configured to releasably attach the one or more patching portions to a front portion of the holding portion.

17. The modular fiber cable patching system according to claim 14, wherein the spool holder portion includes a retaining portion structurally configured to move between a secure position in which the retaining portion secures the cable spool portion in the spool holder portion and a release position in which the cable spool portion may be removed from the spool holder portion.

18. The modular fiber cable patching system of claim 17, wherein the retaining portion includes a pair of flexible portions structurally configured to flex in order to move the retaining portion from the secure position to the release position.

19. The modular fiber cable patching system of claim 18, wherein the cover portion further comprises a projecting portion extending from an inner face of the cover portion, wherein the projecting portion is structurally configured to flex the pair of flexible portions into engagement with the cable spool portion to prevent rotation of the cable spool portion relative to the spool holder portion.

20. The modular fiber cable patching system according to claim 14, wherein the cable spool portion has an oval shape and the storage portion is structurally configured to store the cable spool portion so as to enhance a storage capacity of excess length of the fiber optic cable.

21. The module fiber cable patching system of claim 14, wherein holding portion is structurally configured to support a pair of patching portions structurally configured for 12F cable or a single patching portion structurally configured for 24F.

22. The modular fiber cable patching system of claim 14, wherein the cable spool holder portion is structurally configured to route the fiber optic cable out of a front portion and a back portion of the storage portion.

23. A modular fiber cable patching arrangement, comprising:
a base portion; and
the fiber management portion of claim 14, wherein the fiber management portion is structurally configured to slide into the base portion via an open front side of the base portion and an open rear side of the base portion.
